(19) United States
(12) Patent Application Publication
(10) Pub. No.: US 2025/0388120 A1
(43) Pub. Date: Dec. 25, 2025

(54) PROACTIVE BATTERY SWAPPING RECOMMENDATION FOR USE WITH ELECTRIC VEHICLES

(71) Applicant: INTERNATIONAL BUSINESS MACHINES CORPORATION, Armonk, NY (US)

(72) Inventors: YANG LIANG, Beijing (CN); Jun Su, Beijing (CN); Su Liu, Austin, TX (US); Karen Beale, Mitchellville, MD (US)

(21) Appl. No.: 18/753,259

(22) Filed: Jun. 25, 2024

(51) Int. Cl. B60L 53/80; B60L 53/65; B60L 53/66

(52) U.S. Cl. CPC B60L 53/80; B60L 53/65; B60L 53/665; B60L 2260/52

(57) ABSTRACT

A method includes: receiving, by a processor set and from a user device, a request to exchange a battery currently in use in an electric vehicle (EV) associated with the user device, the request including user-selected values of battery parameters; identifying, by the processor set, a replacement battery for the EV based on the user-selected values of battery parameters; providing, by the processor set, a recommendation of the replacement battery to the user device; receiving, by the processor set, approval of the replacement battery from the user device; and in response to receiving the approval, providing, by the processor set, instructions to an EV battery swapping system to exchange the battery currently in the EV with the replacement battery.

### BACKGROUND

Aspects of the present invention relate generally to electric vehicles and, more particularly, to battery swapping in electric vehicles.

Electric vehicles (EVs) use electric motors powered by rechargeable batteries for propulsion. As a vehicle propelled by an electric motor is operated, a battery of the vehicle is discharged to power the electric motor. When the battery is fully discharged, the electric motor can no longer function to propel the vehicle using the battery. Such vehicles require a mechanism by which to obtain additional electrical energy to remain operable via the electric motor. One such mechanism is a recharging station where the EV may be plugged in to a charging source that recharges the battery in the EV. Another such mechanism is a battery swapping station where a depleted battery in the EV is removed and replaced with a charged battery.

### SUMMARY

In a first aspect of the invention, there is a computer-implemented method including: receiving, by a processor set and from a user device, a request to exchange a battery currently in use in an electric vehicle (EV) associated with the user device, the request including user-selected values of battery parameters; identifying, by the processor set, a replacement battery for the EV based on the user-selected values of battery parameters; providing, by the processor set, a recommendation of the replacement battery to the user device; receiving, by the processor set, approval of the replacement battery from the user device; and in response to receiving the approval, providing, by the processor set, instructions to an EV battery swapping system to exchange the battery currently in the EV with the replacement battery.

In another aspect of the invention, there is a computer program product including one or more computer readable storage media having program instructions collectively stored on the one or more computer readable storage media. The program instructions are executable to: receive, from a user device, a request to exchange a battery currently in use in an electric vehicle (EV) associated with the user device, the request including user-selected values of battery parameters; identify a replacement battery for the EV based on the user-selected values of battery parameters; provide a recommendation of the replacement battery to the user device; receive approval of the replacement battery from the user device; and in response to receiving the approval, provide instructions to an EV battery swapping system to exchange the battery currently in the EV with the replacement battery.

In another aspect of the invention, there is a system including a processor set, one or more computer readable storage media, and program instructions collectively stored on the one or more computer readable storage media. The program instructions are executable to: receive, from a user device, a request to exchange a battery currently in use in an electric vehicle (EV) associated with the user device, the request including user-selected values of battery parameters; identify a replacement battery for the EV based on the user-selected values of battery parameters; provide a recommendation of the replacement battery to the user device; receive approval of the replacement battery from the user device; and in response to receiving the approval, provide instructions to an EV battery swapping system to exchange the battery currently in the EV with the replacement battery.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a hierarchical organization of elements of a Proactive Battery Swapping Recommendation (PBSR) system in accordance with aspects of the invention.

FIG. 4 shows a block diagram of an exemplary method in an environment in accordance with aspects of the present invention.

FIG. 5 illustrates exemplary PBSR data for two exemplary use cases in accordance with aspects of the present invention.

FIG. 6 shows a flowchart of an exemplary method in accordance with aspects of the present invention.

### DETAILED DESCRIPTION

Aspects of the present invention relate generally to electric vehicles and, more particularly, to battery swapping in electric vehicles. Battery swapping has emerged as an alternative approach to rapidly replenishing an EVs energy capacity. For example, the battery swapping market is projected to grow through at least year 2027, with several automakers and startups entering the battery swapping market each with its own approach and technology. Battery swapping stations are often deployed as part of pilot programs or for specific commercial use cases, such as taxi fleets or delivery services. These programs aim to test the viability of battery swapping and gather user feedback. Battery swapping is particularly appealing for commercial fleets, such as electric taxis and delivery vehicles, where minimizing downtime and maintaining consistent range is advantageous. Battery swapping services offer an alternative to traditional EV charging by allowing drivers to quickly replace a depleted battery with a fully charged one. This can significantly reduce charging times compared to conventional charging methods. Battery swapping services have the potential to be more sustainable by using recycled or repurposed batteries, thereby reducing the need for new battery manufacturing. Environmental concerns and sustainability are key drivers for some companies.

Despite the aforementioned benefits of battery swapping, the implementation of battery swapping services faces a number of problems that impact their adoption and effectiveness. A first problem is associated with battery degradation and user trust. EV batteries degrade over time, resulting in reduced energy storage capacity and range. This presents a significant concern for battery swapping services, as users may be apprehensive about the condition and performance of the swapped batteries. The lack of transparency regarding the state of batteries, as well as the absence of clear guidelines for assessing battery health, has contributed to this issue. To promote trust and confidence in battery swapping, there is a pressing need to develop a dynamic and precise method for assessing battery health in real time. Furthermore, communicating this information transparently to users is paramount. A second problem is associated with optimal battery selection. Choosing the most suitable battery for a specific user’s needs and preferences is another challenge. Different users have varying requirements in terms of range, cost, and battery performance. Existing battery swapping services lack an advanced system for proactively recommending batteries based on these requirements. This results in a less-than-optimal user experience, where users may not receive the best battery for their particular situation. As such, there exists a need for a battery swapping recommendation service that recommends the most suitable battery for a user’s needs in an EV battery swapping station, wherein the service enhances user trust in the battery swapping process, streamlines the battery swapping process, and contributes to the adoption of battery swapping services as a convenient, efficient, and sustainable alternative to traditional EV charging.

Implementations of the invention address this need, and provide a technical solution to the aforementioned problems, by providing a Proactive Battery Swapping Recommendation (PBSR) service that represents a significant advancement in battery swapping services, addressing the challenges of battery degradation, user trust, and optimal battery selection. By enabling dynamic Internet-of-Things (IoT) based health assessment and classification, embodiments transform the EV user experience and support the evolution of electric mobility.

Embodiments represent an innovative paradigm shift in EV battery swapping services. As noted above, traditional battery swapping services face challenges related to user trust, optimal battery selection, and transparency in battery health assessment. In contrast, implementations of the present invention introduce a comprehensive solution that leverages dynamic IoT-based battery health assessment, real-time classification, and proactive battery recommendations.

Embodiments leverage deployed IoT sensors to continuously monitor key battery parameters and assess battery health in real time. Using sophisticated data analysis algorithms, batteries may be dynamically classified into categories such as “Excellent,” “Good,” “Normal,” and “Qualified,” based on their actual condition. In parallel, a user-friendly interface allows EV users to input their specific requirements, enabling the system to proactively recommend the most suitable battery for their needs.

Embodiments provide a transparency feature via users receiving detailed information about recommended batteries, their classifications, and pricing structures. User feedback may be integrated to further enhance system accuracy and user trust. In this manner, implementations promote sustainability by encouraging the reuse and recycling of batteries, aligning with environmental objectives.

Embodiments add remote monitoring and management capabilities for ensuring ongoing battery health and classification adjustments, providing a consistent, efficient, and user-centric battery swapping experience. As a data-driven approach, embodiments optimize battery selection, enhance the user experience, and contribute to the broader goals of electric vehicle adoption and sustainability.

Embodiments of the invention have a practical application because embodiments provide a technical solution to a problem in the technical field of EV battery swapping. Conventional battery swapping services suffer from a lack of user trust that stems from a lack of transparency about the condition of the battery the user may receive via a battery swap in exchange for the battery currently in their EV. Implementations of the invention provide a technical solution to this problem by performing IoT sensor-based battery health assessment of batteries in inventory at battery swapping stations, performing real-time classification of the batteries based on the assessment, and providing proactive battery recommendations based on the classifications and in response to a user request for a specific classification of battery. In this manner, implementations of the invention provide the user with transparency about the condition of the battery the user will receive via a battery swap. This transparency enhances user trust in, and improves the user experience with, the battery swapping service and, thus, represents an improvement in the technical field of EV battery swapping.

Embodiments of the invention have a practical application because embodiments are implemented using, or in conjunction with, a particular machine in the form of an EV battery swapping system. For example, various embodiments involve identifying a replacement battery for an EV from a plurality of available replacement batteries in an EV battery swapping system and providing instructions to the EV battery swapping system to exchange the battery currently in use in the EV with the replacement battery. An EV battery swapping system is not a conventional computer device. Instead, an EV battery swapping system has specialized software and hardware, including at least one robotic component, that is configured to automatically remove a battery from an EV and install another battery into the EV. For example, some EV battery swapping system include a drive-in facility in which the user parks their EV while a robotic component of the EV battery swapping system swaps the battery currently in the EV with a replacement battery, all while the user remains in their parked EV.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as battery swapping recommendation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

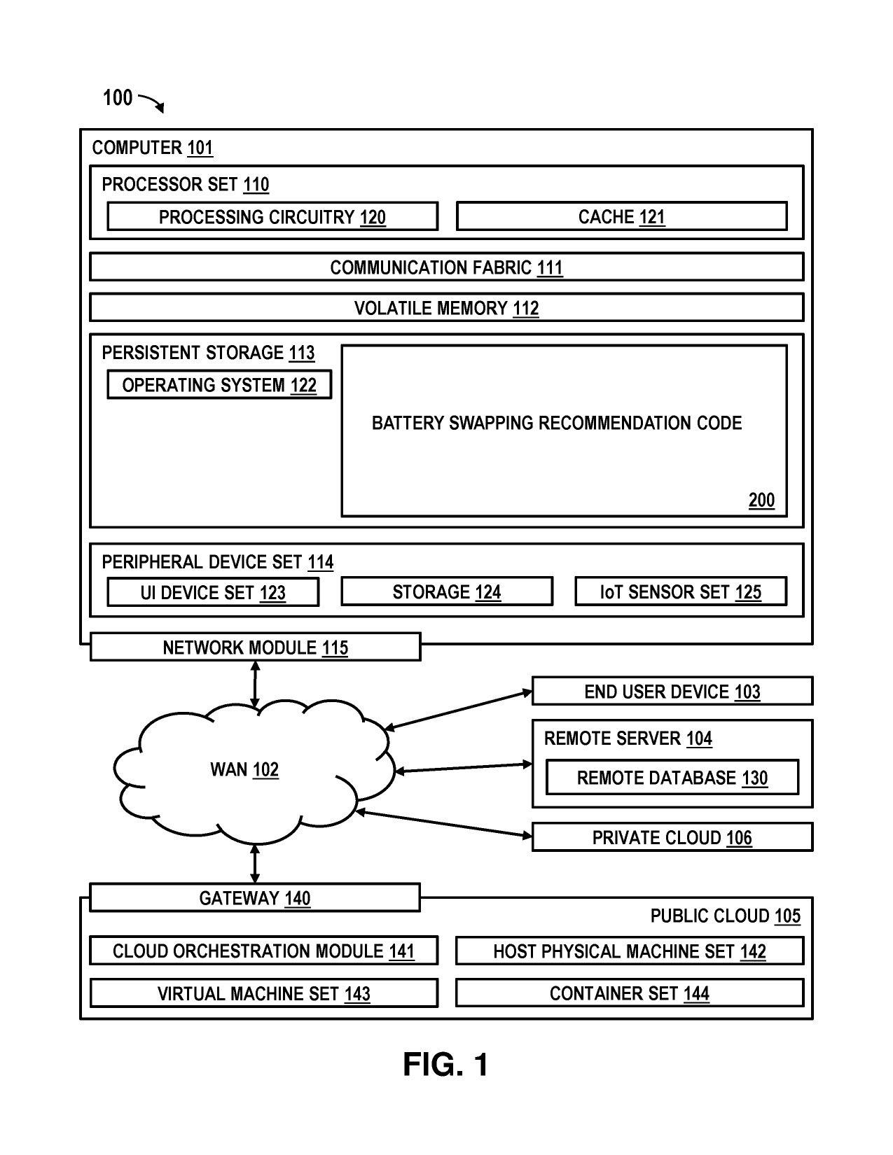

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

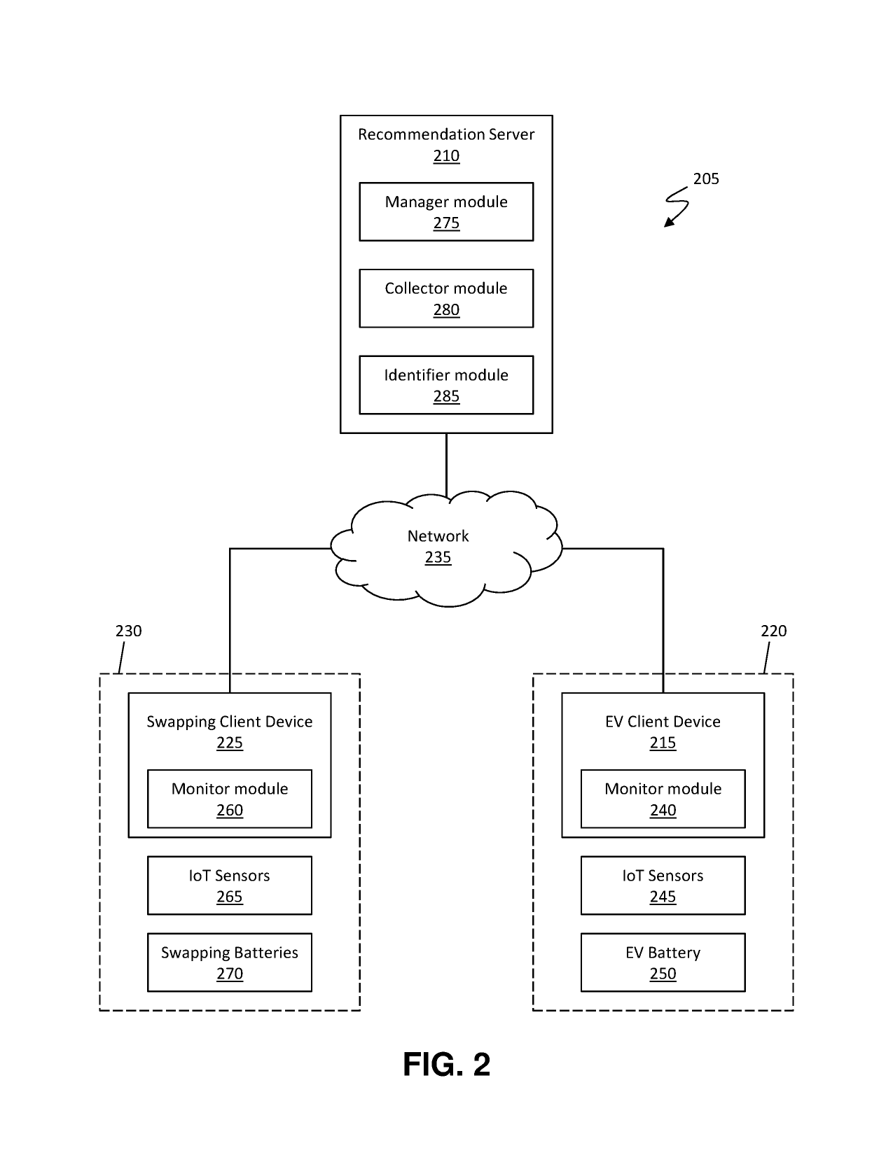

FIG. 2 shows a block diagram of an exemplary environment 205 of a PBSR system in accordance with aspects of the invention. In embodiments, the environment 205 includes a recommendation server 210 that communicates with an EV client device 215 of an EV 220 and a swapping client device 225 of an EV battery swapping system 230 via a network 235. In one example, the recommendation server 210 comprises one or more instances of the computer 101 of FIG. 1. In another example, the recommendation server 210 comprises one or more virtual machines (VMs) or one or more containers running on one or more instances of the computer 101 of FIG. 1. The network 235 may comprise the WAN 102 of FIG. 1.

In embodiments, the EV client device 215 comprises one or more EUDs 103 of FIG. 1. In one example, the EV client device 215 may comprise a hand-held device such as a smartphone, tablet computer, laptop computer, etc. In another example, the EV client device 215 may comprise a computing device integrated with the EV 220, such as a vehicle on-board computer embedded within the EV 220. The EV 220 itself may comprise any EV that is capable of having its battery removed and replaced by another battery via an EV battery swapping system. In accordance with aspects of the invention, the EV client device 215 runs a monitor module 240, which is a software program that monitors signals of one or more IoT sensors 245 that are equipped in the EV 220 to detect one or more conditions of an EV battery 250 installed in the EV 220. In embodiments, the IoT sensors 245 comprise one or more sensors that detect parameters of the EV battery 250 such as one or more of battery capacity, battery voltage, battery current, and number of charge/discharge cycles. The IoT sensors 245 may additionally comprise one or more sensors that are capable of monitoring user feedback, such as microphone that converts speech of the user to a signal. The IoT sensors 245 may be hardware sensors, software sensors, or hardware and software sensors.

In embodiments, the swapping client device 225 comprises one or more EUDs 103 of FIG. 1. For example, the swapping client device 225 may comprise a smartphone, tablet computer, laptop computer, desktop computer, etc., that is configured to control one or more processes of the EV battery swapping system 230. In accordance with aspects of the invention, the swapping client device 225 runs a monitor module 260, which is a software program that monitors signals of one or more IoT sensors 265 that are equipped in the EV battery swapping system 230 to detect one or more conditions of one or more swapping batteries 270 in inventory in the EV battery swapping system 230. In embodiments, the IoT sensors 265 are one or more sensors that detect parameters of the swapping batteries 270 such as one or more of battery capacity, battery voltage, battery current, and number of charge/discharge cycles. The IoT sensors 265 may be hardware sensors, software sensors, or hardware and software sensors.

In embodiments, the recommendation server 210 of FIG. 2 comprises a manager module 275, a collector module 280, and an identifier module 285, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The recommendation server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

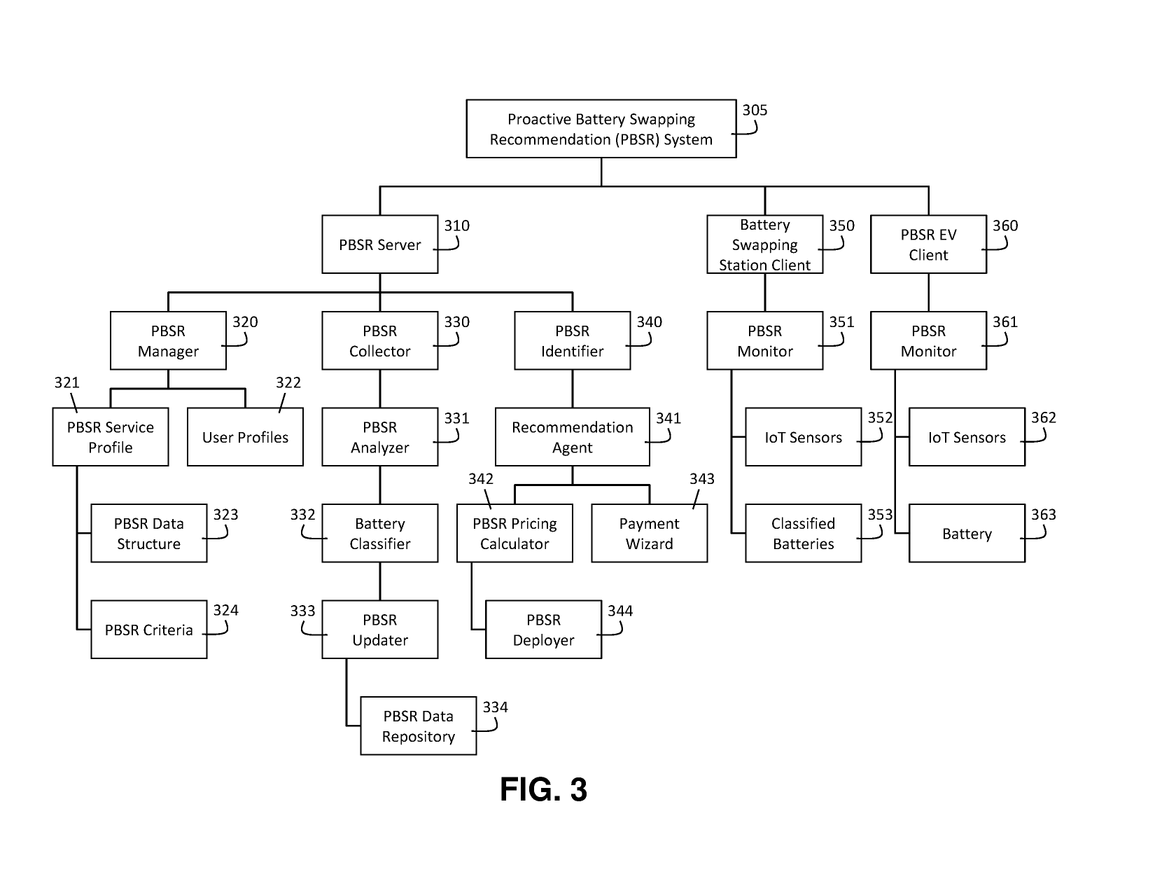

In accordance with aspects of the invention, the manager module 275 is configured to perform configuration functions of the PBSR system. In embodiments, and as described with respect to FIG. 3, such configuration functions may include permitting an administrator to define administrative settings for the PBSR system and permitting users to define user settings for the PBSR system. In embodiments, these settings are utilized by the collector module 280 and the identifier module 285 in performing their respective functions.

In accordance with aspects of the invention, the collector module 280 is configured to perform learning and analyzing functions of the PBSR system. In embodiments, and as described with respect to FIG. 3, such learning and analyzing functions include: collecting PBSR data from the monitor modules 240 and 260; assessing health of the EV battery 250 and each of the swapping batteries 270 based on the PBSR data; determining a battery health classification for the EV battery 250 and each of the swapping batteries 270 based on the assessed health of each battery; and updating a PBSR data structure with the determined battery health classification for each battery.

In accordance with aspects of the invention, the identifier module 285 is configured to perform real time service functions of the PBSR system. In embodiments, and as described with respect to FIG. 3, such real time service functions include: receiving a battery swapping request from the EV client device 215; identifying which of the swapping batteries 270 satisfies the battery swapping request; providing a recommendation to the EV client device 215 that recommends the identified one of the swapping batteries 270; receiving approval from the EV client device 215 to perform the battery swap using the identified one of the swapping batteries 270; deploying the EV battery swapping system 230 to perform the battery swap in the EV 220 using the identified one of the swapping batteries 270; determining a price for performing the battery swap; and providing a payment wizard to the user via the EV client device 215 to perform payment of the determined price.

FIG. 3 shows a hierarchical organization of elements of a Proactive Battery Swapping Recommendation (PBSR) system 305 in accordance with aspects of the invention. In various embodiments, the PBSR system 305 includes a PBSR server 310, a battery swapping station client 350, and a PBSR EV client 360 that correspond, respectively, to the recommendation server 210, swapping client device 225, and EV client device 215 of FIG. 2. In the example shown in FIG. 3, the PBSR server 310 includes a PBSR manager 320, a PBSR collector 330, and a PBSR identifier 340 that correspond, respectively, to the manager module 275, collector module 280, and identifier module 285 of FIG. 2.

In embodiments, the PBSR manager 320 performs configuration functions of the PBSR system 305. In one example of a configuration function, the PBSR manager 320 allows administrators to create a PBSR service profile 321 that is used to configure administrative settings of the PBSR system 305. Administrative settings may include but are not limited to: type, manufacturer, and model of replacement batteries; one or more algorithms used by the PBSR system 305 for determining a battery health classification of a battery; predefined values of one or more battery parameters. In various examples, the settings in the PBSR service profile 321 include PBSR criteria 324, which include prices for different battery conditions, pricing structure, and acceptable payment methods. In embodiments, the settings in the PBSR service profile 321 include a definition of what types of data are included in the PBSR data structure 323, along with related algorithms for saving, tracking, analyzing, and using PBSR data. In one exemplary implementation, the types of data defined in the PBSR data structure 323 include: a first battery health condition comprising a user identifier (ID) (e.g., an identifier of a user), an EV ID (e.g., an identifier of an EV associated with the user), a battery ID (e.g., an identifier of a battery currently in the EV associated with the user), and a class ID (e.g., an identifier of a classification of the battery currently in the EV associated with the user); and a second battery health condition comprising a swapping station ID (e.g., an identifier associated with an EV battery swapping station), a battery ID (e.g., an identifier of a battery in an inventory of the EV battery swapping station), and a class ID (e.g., an identifier of a classification of the battery in the inventory of the EV battery swapping station); user preferences; and prices of different classes of batteries.

In another example of a configuration function, the PBSR manager 320 allows respective users to create respective user profiles 322 that are used to configure user settings of the PBSR system 305. In one example, the user profiles 322 include data input by a user that defines settings for the user including but not limited to: user ID; EV ID; user preferred options such as preferred classification of replacement battery and preferred cost level for replacement battery; and a payment method authorized by the user to pay for a battery swap in the EV of the user.

In embodiments, and with continued reference to FIG. 3, the PBSR collector 330 performs learning and analyzing functions of the PBSR system 305. In one exemplary implementation, the PBSR collector 330 collects PBSR data from the battery swapping station client 350 and the PBSR EV client 360. The PBSR data may include data obtained by the PBSR monitor 351 from IoT sensors 352 associated with classified batteries 353 in the inventory of the EV battery swapping station associated with the battery swapping station client 350. The PBSR data may also include data obtained by the PBSR monitor 361 from IoT sensors 362 associated with the battery 363 in an EV associated with a user. In embodiments, the PBSR collector 330 includes a PBSR analyzer 331 that analyzes the collected PBSR data to assess the health of the classified batteries 353 and the battery 363 in real time. In embodiments, the PBSR analyzer 331 assesses the health of a battery using any conventional or later developed algorithm for assessing battery health based on sensor data comprising one or more of battery capacity, battery voltage, battery current, and number of charge/discharge cycles of the battery, for example by determining a health score for the battery and a predicted mileage range provided by the battery using such an algorithm. The algorithm used by the PBSR analyzer 331 to assess the battery health of the batteries may be defined by an administrator in the PBSR service profile 321 and/or the PBSR criteria 324.

In embodiments, the PBSR collector 330 includes a battery classifier 332 that classifies the classified batteries 353 and the battery 363 into one of plural predefined battery health classifications based on the assessed health of each battery as determined by the PBSR analyzer 331. In one example, there are four predefined battery health classifications including excellent, good, normal, and qualified. This is a nonlimiting example and other numbers of predefined battery health classifications may be used, and differently named predefined battery health classifications may be used. Continuing this example, an exemplary algorithm for classifying a battery based on its assessed battery health is based on thresholds in which the battery classifier 332 classifies a battery having a health score (e.g., from the PBSR analyzer 331) less than a first threshold value as qualified, a battery having a health score greater than the first threshold value and less than a second threshold value as normal, a battery having a health score greater than the second threshold value and less than a third threshold value as good, and a battery having a health score greater than the third threshold value as excellent. The number of predefined battery health classifications, the names of the predefined battery health classifications, and the classification algorithm including the threshold values may be defined by an administrator in the PBSR service profile 321 and/or the PBSR criteria 324.

In embodiments, the PBSR collector 330 includes a PBSR updater 333 that updates the PBSR data structure 323 stored in a PBSR data repository 334 with determined battery health classifications for each of the classified batteries 353 and the battery 363. As noted above, the PBSR collector 330 may correspond to the collector module 280 of FIG. 2, and the PBSR analyzer 331, battery classifier 332, and PBSR updater 333 may be modules contained in or called by the collector module 280. Further, the battery swapping station client 350, the PBSR monitor 351, the IoT sensors 352 and the classified batteries 353 may correspond, respectively, to the swapping client device 225, monitor module 260, IoT sensors 265, and swapping batteries 270 of FIG. 2. Similarly, the PBSR EV client 360, the PBSR monitor 361, the IoT sensors 362 and the battery 363 may correspond, respectively, to the EV client device 215, monitor module 240, IoT sensors 245, and EV battery 250 of FIG. 2.

In embodiments, and with continued reference to FIG. 3, the PBSR identifier 340 performs real time service functions of the PBSR system 305. In one exemplary implementation, the PBSR identifier 340 receives a battery swapping request from a user device associated with a user ID, identifies user preferences for this user (e.g., preferred classification of replacement battery and preferred cost level for replacement battery) from the user profiles 322, and identifies the battery health classification of the battery 363 in the EV associated with this user (e.g., from the PBSR data structure 323 stored in the PBSR data repository 334). In embodiments, the PBSR identifier 340 includes a recommendation agent 341 that identifies a replacement battery for the EV of the user that submitted the battery swapping request. In embodiments, the recommendation agent 341 identifies the replacement battery from the classified batteries 353 currently in inventory at the EV battery swapping station by determining which of the classified batteries 353 satisfies values of battery parameters selected by the user associated with the EV. The battery parameters selected by the user may be included in the battery swapping request or may be defined in the user profiles 322 for this user. For example, the user may utilize a user interface of a user device (e.g., EV client device 215 of FIG. 2) to make the battery swapping request, and the user may provide input via the user interface to select values for each predefined battery parameter as part of the battery swapping request. In this example, the recommendation agent 341 identifies a replacement battery from the classified batteries 353 based on the replacement battery having a battery health classification (e.g., from the PBSR data structure 323 stored in the PBSR data repository 334) that satisfies the user-selected values included in the battery swapping request.

In embodiments, the recommendation agent 341 uses one or more rules or algorithms defined in the PBSR service profile 321 and/or PBSR criteria 324, along with the user-selected values of battery parameters, and the battery health classifications and predicted mileage range of the classified batteries 353 to identify one or more of the of the classified batteries 353 that satisfy the battery swapping request. For example, a request may include a user-selected value for mileage range provided by the replacement battery and a user-selected value for the battery health classification of the replacement battery. In this example, the PBSR data structure includes data that defines a predicted mileage range provided by each of the classified batteries 353 (e.g., determined by the PBSR analyzer 331) and a battery health classification for each of the classified batteries 353 (e.g., determined by the PBSR classifier 332). In this example, the recommendation agent 341 uses an algorithm that compares the user-selected value for mileage range to the predicted mileage range provided by each of the classified batteries 353 and that compares the user-selected value for the battery health classification to the determined value for the battery health classification of each of the classified batteries 353, and that attempts to find one or more of the classified batteries 353 that have a predicted mileage range and a battery health classification that match the user-selected values. In this manner, the recommendation agent 341 recommends one or more suitable batteries for swapping into the EV of the user that made the battery swapping request according to the user’s preferences (e.g., indicated in the battery swapping request or the user profile), the current battery health assessments, and the available classified batteries 353 in each different classification. This example algorithm is not limiting, and other more sophisticated algorithms may be used in identifying the replacement battery.

In embodiments, the PBSR identifier 340 includes a PBSR pricing calculator 342, a payment wizard 343, and a PBSR deployer 344. The PBSR pricing calculator 342 calculates a cost (e.g., price charged to the user of the EV) for performing the requested battery swapping service. In embodiments, the PBSR pricing calculator 342 calculates the cost based on an agreed-upon pricing structure (e.g., from the PBSR service profile 321) that factors in the classification of the replacement battery and that communicates the cost to the user based on the recommended replacement battery. The payment wizard 343 provides an interface by which the user may make a payment of the cost for performing the requested battery swapping service, as determined by the PBSR pricing calculator 342. The payment wizard 343 ensures user trust and pricing transparency. The PBSR deployer 344 provides instructions to the EV battery swapping station (e.g., the EV battery swapping system 230 of FIG. 2) to exchange the battery currently in the EV (e.g., the EV 220 of FIG. 2) with the replacement battery. The instructions may be to a human that manually performs the battery swapping. The instructions may alternatively be to one or more robotic components of an automated EV battery swapping station that performs the battery swapping by removing the battery currently in the EV and installing the replacement battery into the EV. As noted above, the PBSR identifier 340 may correspond to the identifier module 285 of FIG. 2, and the recommendation agent 341, PBSR pricing calculator 342, payment wizard 343, and PBSR deployer 344 may be modules contained in or called by the collector module 280.

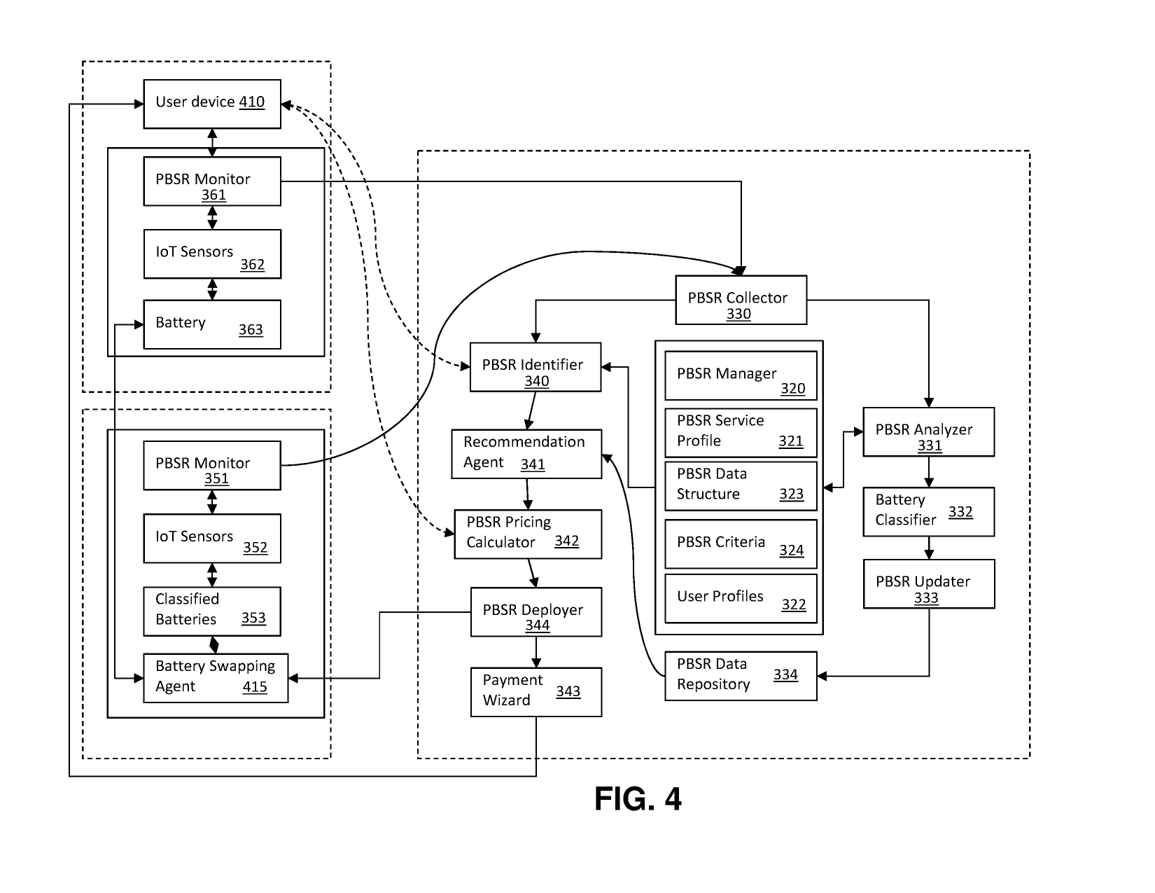

FIG. 4 shows a block diagram of an exemplary method in an environment in accordance with aspects of the present invention. Steps of the method may be carried out using the system of FIG. 3 and are described with reference to elements depicted in FIG. 3.

In various embodiments, and with reference to FIG. 4, the IoT sensors 362 collect data associated with battery 363 in the EV of a user (e.g., EV 220 of FIG. 2), and the IoT sensors 352 collect data associated with plural classified batteries 353 in the inventory of an EV battery swapping station (e.g., EV battery swapping system 230 of FIG. 2). The PBSR monitor 361 obtains the data from the IoT sensors 362, and the PBSR monitor 351 obtains the data from the IoT sensors 352. The PBSR collector 330 collects this data from the PBSR monitor 351 and the PBSR monitor 361 and provides the data to the PBSR analyzer 331, which uses the data with one or more algorithms obtained from the PBSR service profile 321 and/or the PBSR criteria 324 to assess the health of the battery 363 and each of the classified batteries 353. The battery classifier 332 uses the assessed health determined by the battery analyzer with one or more rules or algorithms obtained from the PBSR service profile 321 and/or the PBSR criteria 324 to determine a respective battery health classification and an expected milage range for the battery 363 and each of the classified batteries 353. The PBSR updater 333 then updates the PBSR data structure 323, which may be stored in the PBSR data repository 334, with the respective battery health classification and mileage range for the battery 363 and each of the classified batteries 353. In embodiments, this process is performed as a background process and repeated periodically (e.g., once every hour or other time period defined in the PBSR service profile and/or PBSR criteria 324), thereby continuously updating the PBSR data structure 323 with newly determined battery health classifications and mileage range for the battery 363 and each of the classified batteries 353.

In various embodiments, and with continued reference to FIG. 4, the user utilizes the user device 410 (e.g., EV client device 215 of FIG. 2) to make a battery swapping request for the EV that contains the battery 363. In embodiments, the user device 410 includes a user interface that permits the user to provide input to select values of values of battery parameters for the request. Examples of such battery parameters include but are not limited to a mileage range parameter and a budget parameter. In embodiments, predefined values for each of the battery parameters are defined by an administrator in the PBSR service profile 321 and/or PBSR criteria 324. In embodiments, the user interface presents (e.g., displays) the predefined values for each of the battery parameters and the user selects one of the predefined values for each of the battery parameters. The battery swapping request including the user-selected values of battery parameters is communicated to the PBSR identifier 340. The PBSR identifier 340 obtains user preferences for this user from the user profiles 322. The recommendation agent 341 receives the battery swapping request including the user-selected values of battery parameters and the user preferences for this user from the PBSR identifier 340 and obtains the battery health classifications and mileage range of all the classified batteries 353 currently in inventory at the EV battery swapping station. The recommendation agent 341 uses one or more rules or algorithms defined in the PBSR service profile 321 and/or PBSR criteria 324, along with the user-selected values of battery parameters, and the battery health classifications and mileage range of the classified batteries 353 to identify one or more of the of the classified batteries 353 that satisfy the battery swapping request, for example by determining which of the classified batteries 353 have a battery health classification that satisfies the user-selected values of battery parameters and optionally any user preferences.

In embodiments, and with continued reference to FIG. 4, the PBSR pricing calculator 342 determines a price for performing a battery swap using the identified one of the classified batteries 353 using one or more pricing rules or algorithms defined in the PBSR service profile 321 and/or PBSR criteria 324. The PBSR server presents a recommendation to the user via the user interface of the user device 410, the recommendation indicating the identified one of the classified batteries 353 (which may also be referred to as the replacement battery), the battery health classification and mileage range of the replacement battery, and the price for performing the battery swap using the replacement battery. In this way, the user is provided with transparency including the battery health classification and mileage range of the replacement battery and the price for swapping using the replacement battery. In response to receiving approval of the recommendation from the user via the user device 410, the PBSR deployer 344 sends instruction to a battery swapping agent 415 associated with the EV battery swapping system. The battery swapping agent 415 may be a computing device monitored by a human that manually performs the battery swapping by removing the battery currently in the EV and installing the replacement battery into the EV. The battery swapping agent 415 may alternatively be an automated system comprising one or more robotic components of an EV battery swapping system that performs the battery swapping by removing the battery currently in the EV and installing the replacement battery into the EV. After the battery swapping is performed, the payment wizard 343 communicates with the user device 410 to complete the payment transaction for the battery swapping.

In an exemplary implementation that uses the four predefined battery health classifications including excellent, good, normal, and qualified, the one or more pricing rules or algorithms may be based on these four predefined battery health classifications. In this example, a battery classified as excellent may be defined as a battery in excellent condition that offers maximum capacity and range for driving the EV, a battery classified as good may be defined as a battery in good condition with slightly reduced capacity compared to excellent, a battery classified as normal may be defined as a battery in acceptable condition suitable for regular use, and a battery classified as qualified may be defined as a battery that meets minimum requirements but may have limited capacity or range. These definitions may be defined by an administrator in the PBSR service profile 321 and/or PBSR criteria 324. An exemplary pricing algorithm for use with these classifications includes a cost of a first amount (e.g., fifty dollars) for a swap in which the replacement battery is classified as excellent, a cost of a second amount (e.g., forty dollars) for a swap in which the replacement battery is classified as good, a cost of a third amount (e.g., thirty dollars) for a swap in which the replacement battery is classified as normal, and a cost of a fourth amount (e.g., twenty dollars) for a swap in which the replacement battery is classified as qualified. These prices may be defined by an administrator in the PBSR service profile 321 and/or PBSR criteria 324. These prices may be changed based on various factors including market conditions, the cost of batteries, and operational expenses. In this example, the pricing structure offers a tiered approach where the cost of swapping a battery varies based on its classification. Users are charged more for batteries in excellent condition, which offer the highest capacity and range. As the battery classification moves down to good, normal, and qualified, the prices decrease to reflect the reduced capacity and range of these batteries. The actual pricing structure can be fine-tuned based on market factors, user demand, and the specific costs associated with battery maintenance and swapping services. Additionally, discounts, promotions, and subscription models could be incorporated into the pricing structure to further meet user preferences and encourage sustainable EV use.

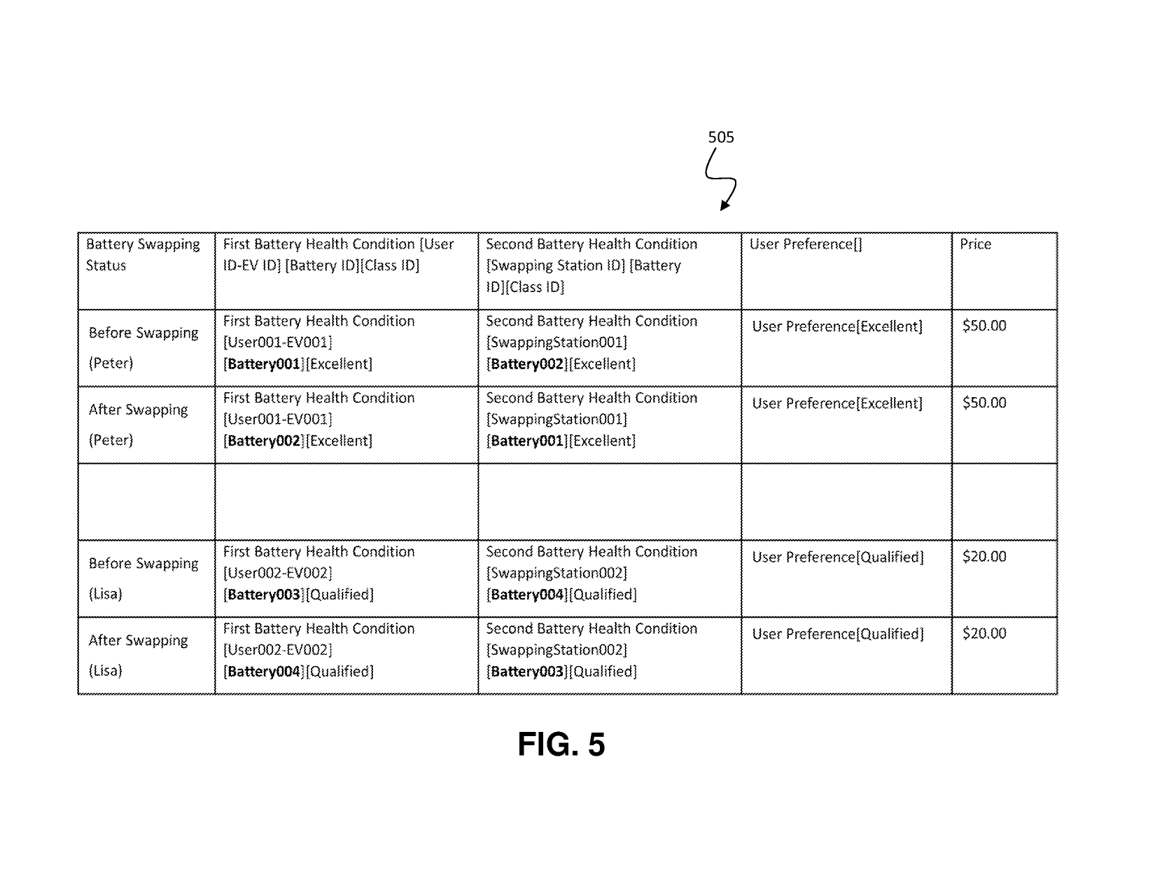

FIG. 5 illustrates exemplary PBSR data 505 updated in real time for two exemplary use cases that employ the exemplary implementation described above, e.g., four predefined battery health classifications including excellent, good, normal, and qualified. In a first of the use cases, Peter owns a new EV and is in need of a battery swap. In this example, Peter is on a long road trip and is looking for a battery that can provide an extended range to reach his destination. Peter utilizes the user interface on his user device to generate a battery swapping request. As part of the generating the battery swapping request, Peter provides input that he has a desired range of 300 miles (e.g., a value of a mileage range parameter) and a budget of high (e.g., a value of a budget parameter). Based on receiving Peter’s battery swapping request including these user-selected values, the PBSR server 310 of FIG. 3 assesses the available batteries in the EV battery swapping station identified in Peter’s request and suggests a replacement battery with an excellent classification that can provide a range of 320 miles. This replacement battery classified as excellent comes at a premium price (e.g., fifty dollars) due to its exceptional condition and extended range. As a result, Peter receives a higher price estimate compared to other batteries.

In a second of the use cases, Lisa owns an old EV with an old battery and needs a battery swap. Lisa primarily uses her EV for short daily commutes and is conscious of her budget. Lisa utilizes the user interface on her user device to generate a battery swapping request. As part of the generating the battery swapping request, Lisa provides input that she has a desired range of 150 miles (e.g., a value of a mileage range parameter) and a budget of economical (e.g., a value of a budget parameter). Based on receiving Lisa’s battery swapping request including these user-selected values, the PBSR server 310 of FIG. 3 assesses the available batteries in the EV battery swapping station identified in Lisa’s request and suggests a replacement battery with a qualified classification that can provide a range of 160 miles. This replacement battery classified as qualified is offered at a more budget-friendly price (e.g., twenty dollars) compared to the price of the battery classified as excellent. In these examples, the PBSR system tailors its recommendations to meet the distinct needs and budget constraints of individual users. For Peter, who requires an extended range, the system recommends a premium excellent battery, whereas for Lisa, who seeks an economical solution, the system suggests a more affordable qualified battery. This approach ensures that EV users receive batteries that align with their specific requirements and financial considerations.

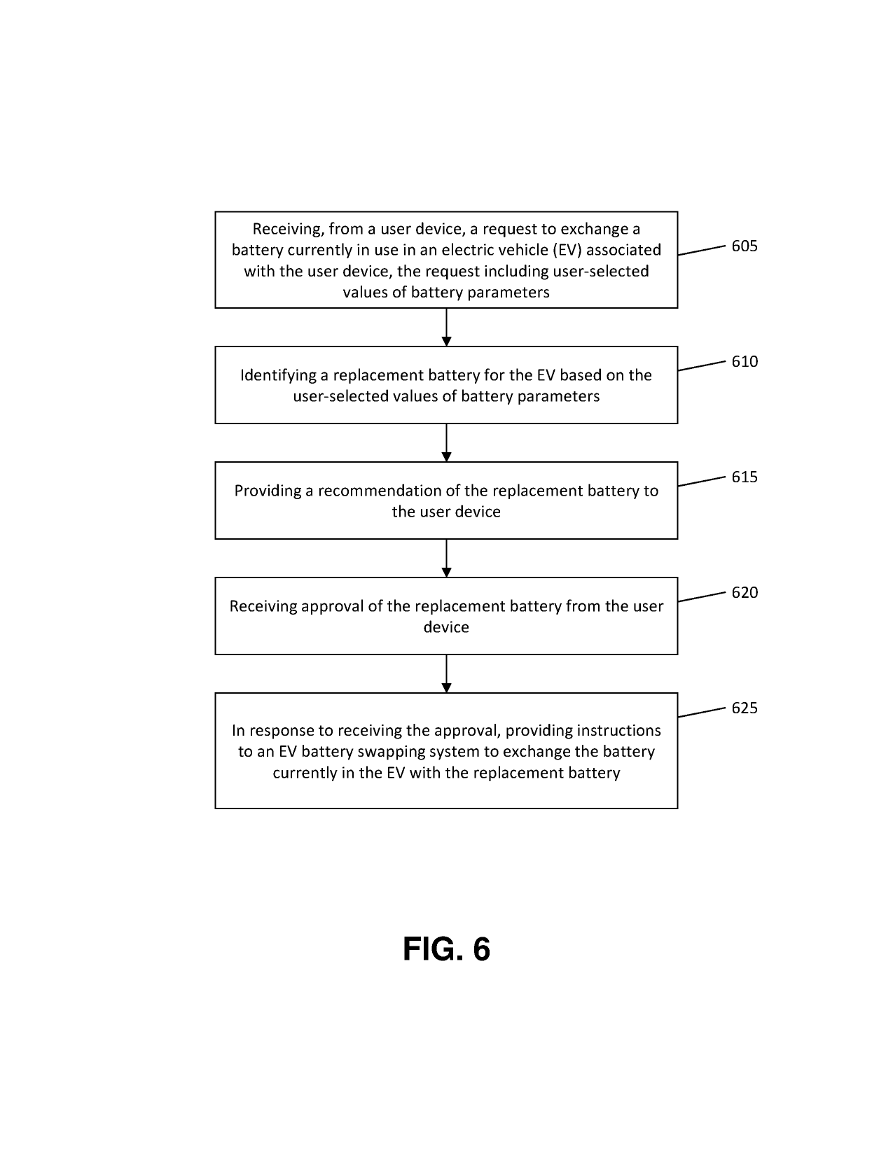

FIG. 6 shows a flowchart of an exemplary method in accordance with aspects of the present invention. Steps of the method may be carried out in the environment of FIGS. 2-4 and are described with reference to elements depicted in FIGS. 2-4.

At step 605, the system receives, from a user device, a request to exchange a battery currently in use in an electric vehicle (EV) associated with the user device, the request including user-selected values of battery parameters. In embodiments, and as described with respect to FIGS. 2-4, the PBSR identifier 340 receives a battery swapping request from a user via a user device 410. The user-selected values may be input by the user when generating the request or may be retrieved from a user profile 322 in which this use has defined their preferences for the values of the battery parameters.

At step 610, the system identifies a replacement battery for the EV based on the user-selected values of battery parameters. In embodiments, and as described with respect to FIGS. 2-4, the recommendation agent 341 receives the battery swapping request including the user-selected values of battery parameters and obtains the battery health classifications of all the classified batteries 353 currently in inventory at the EV battery swapping station indicated in the request. The recommendation agent 341 uses one or more rules or algorithms defined in the PBSR service profile 321 and/or PBSR criteria 324, along with the user-selected values of battery parameters and the battery health classifications of the classified batteries 353 to identify one or more of the of the classified batteries 353 that satisfy the battery swapping request, for example by determining which of the classified batteries 353 have a battery health classification that satisfies the user-selected values of battery parameters and optionally any user preferences.

At step 615, the system provides a recommendation of the replacement battery to the user device. In embodiments, and as described with respect to FIGS. 2-4, the PBSR server transmits a recommendation to the user via the user interface of the user device 410, the recommendation indicating the identified one of the classified batteries 353 (which may also be referred to as the replacement battery), the battery health classification of the replacement battery, and the price for performing the battery swap using the replacement battery.

At step 620, the system receives approval of the replacement battery from the user device. In embodiments, and as described with respect to FIGS. 2-4, the user utilizes the user interface of the user device to provide user input indicating the user approves the recommendation.

At step 625, in response to receiving the approval, the system provides instructions to an EV battery swapping system to exchange the battery currently in the EV with the replacement battery. In embodiments, and as described with respect to FIGS. 2-4, the PBSR deployer 344 sends instruction to a battery swapping agent 415 associated with the EV battery swapping system.

In embodiments of the method, the battery parameters include one or more selected from a group consisting of: battery health classification; mileage range; and budget. In a particular embodiment, the battery parameters include a mileage range parameter and a budget parameter.

In embodiments of the method, the identifying comprises determining that a battery health classification of the replacement battery, including an expected mileage, satisfies the user-selected values of battery parameters. For example, the system may determine that the expected mileage range of the replacement battery satisfies the user-selected value of a mileage range parameter, and that the price associated with the battery health classification of the replacement battery satisfies the user-selected value of a budget range parameter.

In embodiments, the method further comprises: collecting respective sensor data associated with respective batteries in an inventory of the EV battery swapping system; and determining a respective battery health classification for each of the respective batteries in the inventory based on the respective sensor data.

In embodiments, the method further comprises collecting the respective sensor data using Internet-of-Things (IoT) sensors associated with the respective batteries in the inventory.

In embodiments of the method, the identifying comprises determining that the respective battery health classification of the replacement battery satisfies the user-selected values of battery parameters.

In embodiments, the method further comprises maintaining a data structure that includes the respective battery health classification for each of the respective batteries in the inventory.

In embodiments, the method further comprises: receiving user feedback about the replacement battery; and updating the data structure based on the user feedback. For example, if a battery was classified as excellent and a user provides feedback that the battery did not perform at the level of an excellent battery (e.g., did not provide the expected mileage to the EV), then in response to this feedback the PBSR server may downgrade the classification of this battery in the PBSR data structure. This is but one example of feedback, and other types of feedback and updates may be used.

In embodiments of the method, the identifying comprises: determining the inventory does not include a battery that satisfies the user-selected values of battery parameters; and determining an alternative battery that is either (i) another battery in the inventory that most closely satisfies the user-selected values of battery parameters or (ii) another battery in another inventory in another EV battery swapping system that satisfies the user-selected values of battery parameters, wherein the replacement battery is the alternative battery. For example, if the EV battery swapping system indicated in the request does not have a battery that fully satisfies the request, then the PBSR server looks for other batteries in the EV battery swapping system indicated in the request that come close to satisfying the request, and looks at other nearby EV battery swapping systems for batteries that fully satisfy the request. In this manner, the system is configured to provide alternatives to the user when the user request cannot be fully satisfied.

In embodiments of the method, the EV battery swapping system comprises an automated EV battery swapping station. In embodiments of the method, the providing instructions to the EV battery swapping system comprises controlling at least one robotic component of the automated EV battery swapping station to remove the battery currently in the EV and install the replacement battery into the EV.

In embodiments, the method further comprises receiving payment from a user associated with the user device for installing the replacement battery into the EV. This may be performed using the payment wizard 343.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set and from a user device, a request to exchange a battery currently in use in an electric vehicle (EV) associated with the user device, the request including user-selected values of battery parameters;
identifying, by the processor set, a replacement battery for the EV based on the user-selected values of battery parameters;
providing, by the processor set, a recommendation of the replacement battery to the user device;
receiving, by the processor set, approval of the replacement battery from the user device; and
in response to receiving the approval, providing, by the processor set, instructions to an EV battery swapping system to exchange the battery currently in the EV with the replacement battery.

2. The computer-implemented method of claim 1, wherein the battery parameters include a mileage range parameter and a budget parameter.

3. The computer-implemented method of claim 1, wherein the identifying comprises determining that a battery health classification of the replacement battery satisfies the user-selected values of battery parameters.

4. The computer-implemented method of claim 1, further comprising:
collecting respective sensor data associated with respective batteries in an inventory of the EV battery swapping system; and
determining a respective battery health classification for each of the respective batteries in the inventory based on the respective sensor data.

5. The computer-implemented method of claim 4, further comprising collecting the respective sensor data using Internet-of-Things (IoT) sensors associated with the respective batteries in the inventory.

6. The computer-implemented method of claim 4, wherein the identifying comprises determining that the respective battery health classification of the replacement battery satisfies the user-selected values of battery parameters.

7. The computer-implemented method of claim 4, further comprising maintaining a data structure that includes the respective battery health classification for each of the respective batteries in the inventory.

8. The computer-implemented method of claim 7, further comprising:
receiving user feedback about the replacement battery; and
updating the data structure based on the user feedback.

9. The computer-implemented method of claim 4, wherein the identifying comprises:
determining the inventory does not include a battery that satisfies the user-selected values of battery parameters; and
determining an alternative battery that is either (i) another battery in the inventory that most closely satisfies the user-selected values of battery parameters or (ii) another battery in another inventory in another EV battery swapping system that satisfies the user-selected values of battery parameters, wherein the replacement battery is the alternative battery.

10. The computer-implemented method of claim 1, wherein the EV battery swapping system comprises an automated EV battery swapping station.

11. The computer-implemented method of claim 10, wherein the providing instructions to the EV battery swapping system comprises controlling at least one robotic component of the automated EV battery swapping station to remove the battery currently in the EV and install the replacement battery into the EV.

12. The computer-implemented method of claim 1, further comprising receiving payment from a user associated with the user device for installing the replacement battery into the EV.

13. A computer program product comprising one or more computer readable storage media having program instructions collectively stored on the one or more computer readable storage media, the program instructions executable to:
receive, from a user device, a request to exchange a battery currently in use in an electric vehicle (EV) associated with the user device, the request including user-selected values of battery parameters;
identify a replacement battery for the EV based on the user-selected values of battery parameters;
provide a recommendation of the replacement battery to the user device;
receive approval of the replacement battery from the user device; and
in response to receiving the approval, provide instructions to an EV battery swapping system to exchange the battery currently in the EV with the replacement battery.

14. The computer program product of claim 13, wherein the battery parameters include a mileage range parameter and a budget parameter.

15. The computer program product of claim 13, further comprising:
collecting respective sensor data associated with respective batteries in an inventory of the EV battery swapping system;
determining a respective battery health classification for each of the respective batteries in the inventory based on the respective sensor data; and
maintaining a data structure that includes the respective battery health classification for each of the respective batteries in the inventory.

16. The computer program product of claim 15, wherein the identifying comprises determining that the respective battery health classification of the replacement battery satisfies the user-selected values of battery parameters.

17. A system comprising:
a processor set, one or more computer readable storage media, and program instructions collectively stored on the one or more computer readable storage media, the program instructions executable to:
receive, from a user device, a request to exchange a battery currently in use in an electric vehicle (EV) associated with the user device, the request including user-selected values of battery parameters;
identify a replacement battery for the EV based on the user-selected values of battery parameters;
provide a recommendation of the replacement battery to the user device;
receive approval of the replacement battery from the user device; and
in response to receiving the approval, provide instructions to an EV battery swapping system to exchange the battery currently in the EV with the replacement battery.

18. The system of claim 17, wherein the battery parameters include a mileage range parameter and a budget parameter.

19. The system of claim 17, further comprising:
collecting respective sensor data associated with respective batteries in an inventory of the EV battery swapping system;
determining a respective battery health classification for each of the respective batteries in the inventory based on the respective sensor data; and
maintaining a data structure that includes the respective battery health classification for each of the respective batteries in the inventory.

20. The system of claim 19, wherein the identifying comprises determining that the respective battery health classification of the replacement battery satisfies the user-selected values of battery parameters.
